(19) United States
(12) Patent Application Publication
(10) Pub. No.: US 2007/0289956 A1
(43) Pub. Date: Dec. 20, 2007

(54) LASER MARKING DEVICE AND METHOD

(76) Inventors: Andriy Knysh, Boca Raton, FL (US); Alexey Moshkov, Boynton Beach, FL (US); Nikolai Krivoruchko, Izyum (UA)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 11/749,351

(22) Filed: May 16, 2007

Related U.S. Application Data
(60) Provisional application No. 60/814,738, filed on Jun. 19, 2006.

(51) Int. Cl. B23K 26/36; B23K 37/00

(52) U.S. Cl. 219/121.68

(57) ABSTRACT

The laser marking device of the present invention utilizes a networked distributed scalable architecture for high-speed simultaneous or sequential marking on a plurality of stationary or moving objects. A plurality of marking units and a controller are connected with one another through a network interface. The controller generates commands and data for the entire marking process and performs general flow control.

### RELATED APPLICATIONS

This application claims priority to U.S. Provisional Patent Application Ser. No. 60/814,738 filed Jun. 19, 2006 incorporated herewith in its entirety.

### FIELD OF THE INVENTION

The present invention relates generally to laser marking and engraving systems and methods.

### BACKGROUND OF THE INVENTION

Laser marking is state-of-the-art technology, which applies computer-generated text, graphics, and machine-readable code on various workpieces, such as, for example, metal, plastic, and elastomeric materials widely used in modern industries. As compared with prior art marking technologies, modern laser marking technology delivers a powerful combination of reduced operating costs and high throughput under complete computer control. There are numerous reasons why the laser marking technology is so popular today. One reason relates to extremely durable method of marking an object. Another reason relates to the fact that lasers produce indelible marks on various workpieces. Yet another reason relates to the speed and accuracy of the marking process. Still another reason relates to the fact that the marks can be changed quickly by computer without re-tooling, as it was done in the prior art applications.

Alluding to the above, the laser marking technology allows engraving directly into the material of a workpiece through a top coating allowing the material underneath to show through. Moreover, the laser marking technology allows chemically altering the surface of the workpiece to create a contrasting mark entirely on the surface, without edges or depth, or cut all the way through films, foils, paper and wood at a high speed. Since laser marking is a non-contact process, it can be used to mark various workpieces that would be damaged by other prior art impact and vibratory marking methods, because laser can reach down to the bottom of blind pockets, into grooves, into the inside bottom of bottles, and other places that only a non-contact beam could reach.

Today, laser marking and engraving systems are widely used throughout different industries for producing high quality marks on production workpieces and parts, including surface annealing, etching, ablating, engraving, and 2D/3D deep engraving. Although majority of the prior art laser marking systems include a set of devices, such as a laser, scan-head, conveyor control module, motion control module, I/O module, and a controller to generate marking commands and data and to provide control of the marking process, all of them fall into two major types with respect to the architecture. One of these types presents a computer with marking process control software wherein a plug-in board inserted into the computer's slot such as PCI, PCI Express, or PCI-X is used to provide all the control signals for all modules constituting the marking system. The board has a circuitry for digital and analog I/O, motion control, conveyor control, etc. The board generates all the necessary signals to control the laser and scan-head, and provides hard real-time control of the marking process. The computer provides marking data and performs general flow control. Another type includes a marking system that has a computer with marking process control software and a stand-alone control module with memory and an embedded processor or microcontroller. The control module can be connected to the computer by the means of a standard interface, usually by Universal Serial Bus (USB) interface. Marking data can be prepared on the computer and then uploaded to the control module via the interface.

Alluding to the above, the control module is disconnected from the computer and autonomously performs general flow control as well as real-time control of the marking process. This type of marking system operates in two distinct modes, such as 1) with a host computer, in which case the control module is connected to the computer via a standard high-speed interface, and 2) stand-alone operation, which executes only static marking instructions, because of the difficulty to dynamically update the control module with a new set of instructions during the marking process. This system also requires a host computer in the close vicinity of the system and also requires the data to be prepared in advance and uploaded to the control module. This system cannot be used on the factory floor autonomously, because the USB interface is a very short range bus and is a peer-to-peer interface, i.e. it always requires a master to be present on the bus. Furthermore, in many cases, the USB interface is not acceptable on the factory floor.

These aforementioned prior art systems present numerous drawbacks and disadvantages. One system always requires a host computer for each marking field with all the corresponding software, i.e. operating system and marking process control software, which is not cost effective, not scalable, not flexible in operation, and is non reliable. Moreover, these prior art systems are not compact, take a lot of space on the factory floor, and have high cost of maintenance. Furthermore, this system can not be easily mounted on a robot arm for marking objects that would be difficult to access otherwise. It is very difficult to combine these systems into a distributed marking network thereby negatively impacting one of the main requirements in a modem laser marking industry.

Summarizing all the above, the main drawback of these marking systems is that it is very difficult to implement an efficient distributed networked marking system to mark on a plurality of spatially separated marking fields, stationary or on moving conveyors. These prior art marking systems are unsuitable for industrial automation because of high cost, inflexibility, very long downtimes, but mostly because of difficulties in implementing real-time algorithms to manage the entire marking network and to control marking processes on each of the marking fields. Implementing the control algorithms would require using marking process control software on each of the host computers, plus a central computer to synchronize all of the host computers in order to simultaneously or sequentially mark different patterns on different marking fields.

These aforementioned prior art systems are taught by various references including the U.S. Pat. Nos. 7,009,633, 6,362,451, 6,262,388, 5,932,119, 5,606,647, 4,803,336, 4,024,545, 6,678,094, 5,821,497, and United States Patent Application Nos. 20030024913, 2005049332, and 1998047035. However, none of these prior art references discloses a system for distributed laser marking on a plurality of stationary or moving objects, and none of them provides a method for controlling the marking process in such a system. Although the aforementioned prior art systems provide accurate control of the marking process on a single marking field, they are not adequate for marking on a plurality of marking fields and for controlling a large network of spatially distributed marking units, and hence they are not practically suitable for industrial automation and process control.

Hence, there is a need for networked distributed scalable marking systems and methods that would not have all of these drawbacks, would greatly decrease the cost of introducing marking systems on the factory floor and increase production throughput. Therefore, it would be desirable to provide an improved system and method for laser marking to eliminate one or more of the aforementioned drawbacks associated with the prior art laser marking devices and methods.

### SUMMARY OF THE INVENTION

An inventive laser marking device utilizes a networked distributed scalable laser marking architecture for high-speed simultaneous or sequential marking on a plurality of workpieces. The laser marking device presents a main controller, which is implemented as a computer, industrial computer, embedded microprocessor, microcontroller, Digital Signal Processor (DSP), Field Programmable Gate Array (FPGA), ASIC, or any combination of these devices, without limiting the scope of the present invention, and a network of distributed marking units connected with one another and the main controller via one of the interfaces like Ethernet, Industrial Ethernet, Control Area Network (CAN), Serial Digital Interface (SDI), Internet protocols, wireless protocols, and the like, without limiting the scope of the present invention. Each marking unit includes, but is not limited to, at least one laser to generate a laser beam, scan-head for two or three-dimensional scanning and for focusing the laser beam on the workpieces, visual recognition module for scanning the workpieces and generating a multi-dimensional image of the workpieces, ID reader module for remotely retrieving marking content and/or workpieces' type information from at least one ID tag attached to or incorporated into at least one of the workpieces, digital and analog I/O module, conveyor module for moving the workpieces relative to the marking units, motion control module to control rotary tables, rotary indexers, and z-axis, automation module to control various interfaces like RS232/485, CAN, SDI, USB, FireWire, Ethernet, and any of the wireless protocols, without limiting the scope of the present invention, and a control module cooperable with the main controller for storing marking data and performing real-time control of the marking process on at least one marking field.

The control module of each marking unit is implemented as a computer, industrial computer, embedded microprocessor, microcontroller, Digital Signal Processor (DSP), Field Programmable Gate Array (FPGA), ASIC, or any combination of these devices, without limiting the scope of the present invention. Preferably, in order for the marking units to consume less space on the factory floor and be mounted on a robot arm, the control module of each marking unit is implemented as a microprocessor, microcontroller, DSP, FPGA, ASIC, or any combination of these devices. The aforementioned modules are integral with each marking unit. Alternatively, these modules are spaced from each marking unit thereby connected to the same through the aforementioned interfaces, without limiting the scope of the present invention.

Alluding to the above, the main controller, communicating with the marking units, generates commands and data for the entire marking process on one or a plurality of marking fields thereby providing general flow-control for the entire marking network. Each marking unit includes a local software application, wherein each marking unit and the main controller are networked through one of the Ethernet, Industrial Ethernet, or wireless protocols, without limiting the scope of the present invention, thereby simultaneously performing marking operation in several shops of a manufacturing facility, if the shops are located in a single manufacturing facility, and by using the Internet between various manufacturing facilities located in different states and countries worldwide.

Preferably, the inventive laser marking system performs sequential or simultaneous marking on a plurality of workpieces movable relative to the marking units by one or a plurality of conveyance devices. Some technological processes require that the type and position of workpieces be recognized in order to perform marking of different types of the workpieces without manually adjusting the marking process workflow. To perform the task, each marking unit includes at least one visual recognition module for scanning the workpieces and generating multi-dimensional images of the workpieces and at least one ID reader module for remotely retrieving the marking content and/or workpieces' type information from at least one ID tag attached to or incorporated into at least one of the workpieces.

The workflow-based method for temporal and spatial marking process control guarantees that only the distributed marking units are involved in hard real-time control of the marking process, sparing the main controller to perform such ‘soft’ real-time tasks as generating marking commands and data for all marking units, moving the data over the network, and providing the status of the marking process on each marking field as well as of the entire network.

An advantage of the present invention is to provide a laser marking system and method that is cost effective and flexibly to be adapted by any manufacturing environment.

Another advantage of the present invention is to provide a laser marking device that is very compact and does not require a lot of space on a factory floor.

Still another advantage of the present invention is to provide a laser marking device that does not have high cost of maintenance and is easily mounted on a robot arm for marking objects that would be difficult to access otherwise.

Still another advantage of the present invention is to provide a laser marking device and method that may simultaneously perform marking operations in several shops of a manufacturing facility through a local network using Ethernet or any of the Industrial Ethernet protocols, and between various manufacturing facilities located in different states and/or countries using the Internet.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 is a schematic view of the marking process according to a first embodiment of the present invention;

FIG. 2 is a schematic view of the marking process according to an alternative embodiment of the present invention;

FIG. 3 represents a networked distributed scalable laser marking system of the present invention;

FIG. 4 illustrates a structure of a single marking unit of the present invention;

FIG. 5 illustrates a structure of a dual marking unit of the present invention;

FIG. 6 is a schematic view of the marking process workflow for temporal control of the marking process in the distributed marking network;

FIG. 7 is another schematic view of the marking process workflow with a repeat activity; and

FIG. 8 is a schematic view of the marking process workflow with two repeat activities and an automation activity.

### DETAILED DESCRIPTION OF THE INVENTION

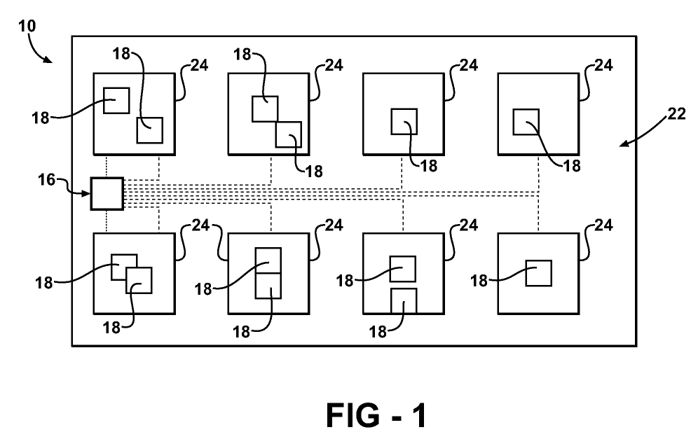

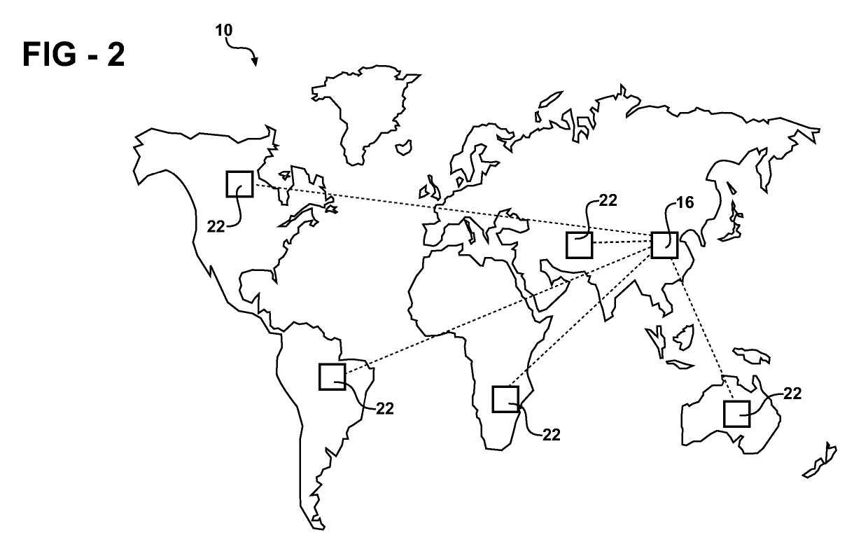

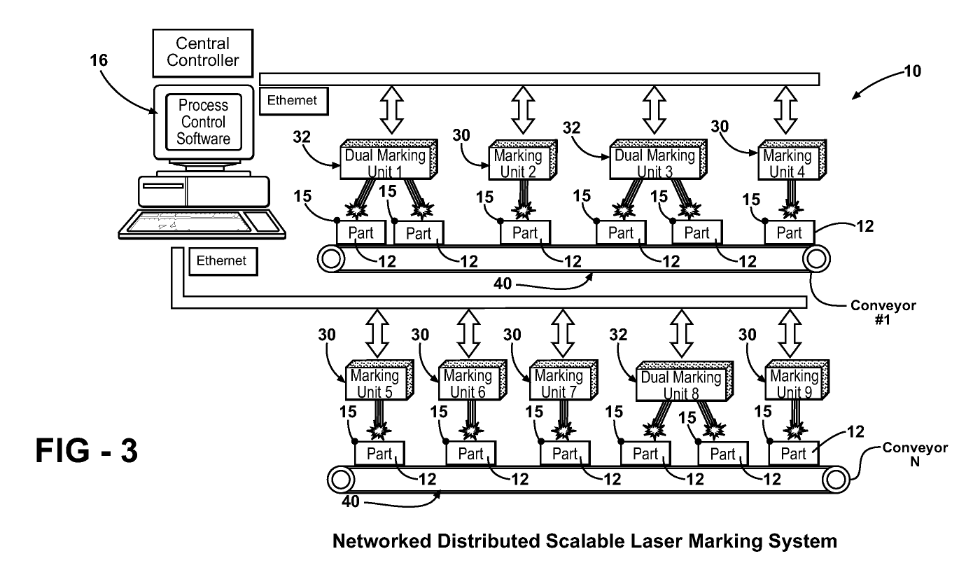

Referring now to Figures, wherein like numerals indicates like or corresponding parts, a laser marking system (the system) of the present invention is generally shown at 10 in FIGS. 1, 2, and 3. The system 10 presents a networked distributed scalable laser marking architecture for high-speed simultaneous or sequential marking on a plurality of workpieces or parts, generally indicated at 12 in FIG. 3. Each part 12 has at least one ID tag associated with it, generally indicated at 15 in FIG. 3, for storing at least one of marking content and part's type information. Each ID tag 15 is further defined as at least one of RFID, magnetic, capacitive, and barcode tags attached to or incorporated into part 12, without limiting the scope of the present invention. The system 10 includes a main controller 16 and a network of distributed marking units 18 networkingly connected with one another and the main controller 16 by Ethernet, Industrial Ethernet, Internet, and/or wireless protocols. The system 10 is adaptable to simultaneously perform marking operations in at least one shop 24 of a manufacturing facility 22 through a local network using the Ethernet interface or any of the Industrial Ethernet or wireless protocols, if the shops are located in a single manufacturing facility, as illustrated in FIG. 1. Alternatively, the system 10 is adaptable to simultaneously perform marking operations in several shops 24 by using the Internet between various manufacturing facilities 22 located in different states and countries worldwide, as illustrated in FIG. 2.

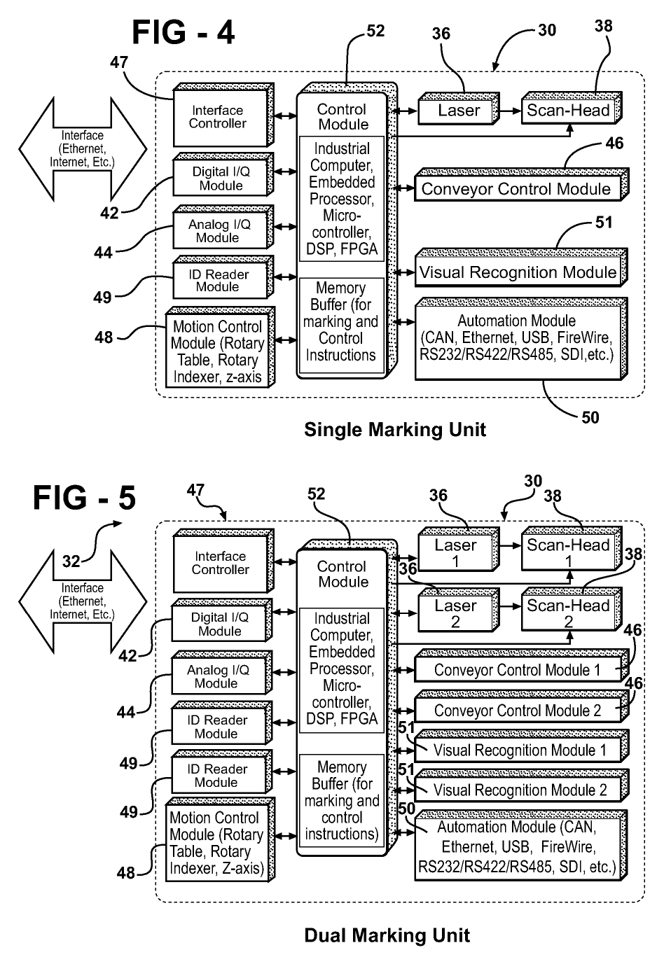

Each marking unit 18 is further defined by a single marking unit, generally shown at 30 in FIGS. 3 and 4, and a dual marking unit, generally shown at 32 in FIGS. 3 and 5. The units 30 and 32 include, but are not limited to, at least one laser 36, a scan-head 38 for two or three-dimensional scanning of the parts and for focusing the laser beam on the parts 12 moveable relative the marking units 30 and 32 by at least one conveyor 40, as shown in FIGS. 3, 4 and 5. The marking units 30 and 32 further include a digital I/O module 42 and an analog I/O module 44, a conveyor control module 46 for controlling the conveyor 40 for moving the parts relative to the marking units 30 and 32, visual recognition module 51, ID reader module 49, and a control module 52 cooperable with the main controller 16 via an interface controller 47. The control module 52 stores marking and control instructions and performs real-time control of the marking process on the corresponding marking field. A motion control module 48 (for controlling rotary tables, rotary indexers, and Z-axis), and an automation module 50 (CAN, Ethernet, RS232/RS422/RS485, USB, FireWire, SDI, wireless interfaces) are also included in the single marking unit 30 and dual marking unit 32. Unlike the single marking unit 30, the dual marking unit 32 includes at least two lasers 36, at least two scan-heads 38, at least two visual recognition modules 51, at least two ID reader modules 49, and at least two conveyor control modules 46. The aforementioned modules 36 through 51 and are integral with the control module 52 and may be implemented, for example, on one Printed Circuit Board (PCB). Alternatively, in order for the marking system to be more flexible, these modules 36 through 51 are spaced from the control module 52 thereby connected to the same through the aforementioned interfaces, without limiting the scope of the present invention.

Each single marking unit 30 controls the marking process on a single marking field. The workpieces to be marked are positioned stationary or moved by the conveyor 40. Several production applications, such as, for example, marking semiconductor wafers and packages, or drilling fuel injector nozzles, require the possibility to perform absolutely synchronous marking on two objects in order to increase production throughput. The dual marking unit 32 is adaptable to simultaneously or sequentially control the marking processes on two different marking fields wherein the workpieces are stationary oriented relative to the marking unit 32 or are moved by at least one conveyor 40.

Other production applications require that the type and position of workpieces 12 be recognized in order to automatically perform marking of different types of workpieces without manually adjusting the marking process workflow. For example, marking of laptop packages would require that different types of packages are moved at the same time by one or a plurality of conveyance devices 40. Usually, the parts 12 are positioned randomly relative to the marking fields. To correctly mark each part, they have to be recognized and the position of the mark adjusted if necessary. Moreover, marking content could be selected automatically for different types of workpieces 12 by the process control software. To perform the task, each marking unit 30 and 32 includes at least one visual recognition module 51 for scanning the workpieces, generating multi-dimensional images of the workpieces, comparing the images with predetermined patterns, and calculating the position of the mark for each workpiece individually as they move along the processing path.

Alluding to the above, each marking unit 30 and 32 includes at leas one ID reader module 49 to remotely retrieve information about marking content and/or the types of the workpieces 12 from at least one ID tags 15 attached to or incorporated into each workpiece 12 as they are moved along the processing path by at least one conveyor 40. According to the present invention, the ID reader module 49 is implemented as an RFID reader, magnetic reader, capacitive reader, and/or barcode reader to retrieve the information about the marking content and the types of the workpieces 12 from RFID tags, magnetic tags, capacitive tags, and/or barcode tags 15 attached to or incorporated into the workpieces 12, without limiting the scope of the present invention. Returning back to the example with marking of different types of laptop packages, each package has, for example, at least one RFID tags 15 attached to it. The packages are randomly positioned on at least one conveyor 40 as they move along the processing path. When a package is moved into the proximity of marking units 30 and 32, the units 30 and 32 read the information about the type of the package from the RFID tags 15 and select the required marking content and marking location from at least one local buffer before performing actual marking thereby allowing automatic control of the marking of different types of packages without manually adjusting the process workflow for each type of packages. Alternatively, the marking content and marking locations for each type of the packages are encoded in at least one RFID tags 15 attached to at least one of the packages. Each marking unit 30 and 32 reads the marking content and marking location from at least one tag 15 thereby automatically marking each package. This flexible architecture allows the same process workflow to be used to process different types of workpieces thereby increasing production throughput, decreasing processing time and production cost, and making the production process generic.

Alluding to the above, each marking unit 30 and 32 is assigned a unique ID, which allows the main controller 16 to send commands and get status of each marking unit 30 and 32. FIG. 3 illustrates one possible spatial configuration of the marking network of the system 10, wherein each marking unit 30 and 32 marks on different production parts 12, which are positioned stationary relative to the marking units 30 and 32 or are movable to and from the marking units 30 and 32 by at least one conveyor 40. The number and operational speed of the conveyors 40 in the system 10 may vary based on applications and without limiting the scope of the present invention. All marking units 30 and 32 get status signals from the corresponding conveyors 40 through the conveyor control module 46, calculate the motion speed, and adjust the marking instructions (the coordinates of the indicia to be marked) dynamically to compensate for the motion of the respective conveyors 40.

Alluding to the above, only one main controller 16 is required to control the marking network. The main controller 16 performs multiple tasks including, but not limited to, generating marking data for each marking unit 30 and 32, distributing data via the network to the corresponding marking unit 30 and 32, and providing the user (not shown) with the status of the marking process on each marking field. In addition to Ethernet, Industrial Ethernet, and the Internet, the main controller 16 is networked with the marking units 30 and 32 through any standard high-speed interface, such as, for example, any of the wireless protocols or Serial Digital Interface (SDI), which has enough bandwidths to provide marking data for each marking field. The main controller 16 communicates with a plurality of the marking units 30 and 32 and all marking units 30 and 32 communicate with each other via TCP/IP protocol, any of the Industrial Ethernet protocols, raw Ethernet frames, or any other network protocol with enough bandwidths to sustain the required network traffic in a marking process. Each marking unit 30 and 32 has a memory with enough capacity to store a whole set or at least a part of all the marking instructions for the corresponding marking field.

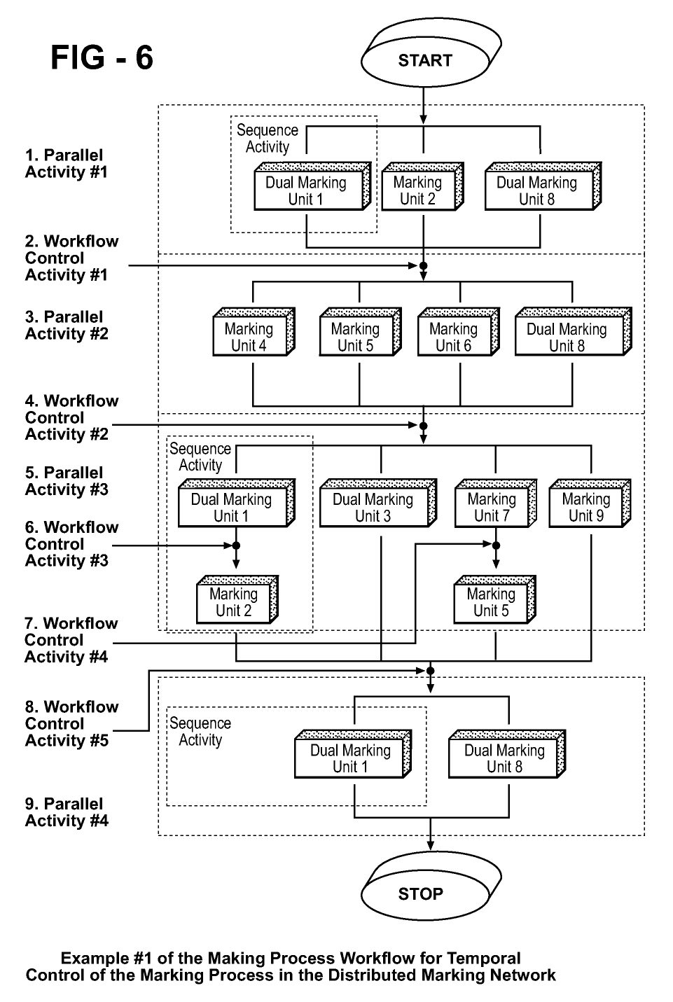

In the marking network, a few of the marking units 30 and 32 execute marking instructions in parallel at any given moment of time. The marking instructions include, but are not limited to: process control and status commands, laser control and status commands; scan-head control and status commands; analog and digital I/O control and status commands; conveyor control and status commands; visual recognition control and status commands; ID reader control and status commands; motion control and status commands; automation control and status commands. After the first set of marking units finishes marking, the next set begins execution. The process repeats until all marking units 30 and 32 finish executing all instructions generated by the main controller 16 and stored in their respective buffers. Based on the technological application, each marking unit 30 and 32 is adaptable to perform marking at different time. One example of the marking process workflow is illustrated in FIG. 6, where the dual marking unit 32 (i.e. unit 1) starts marking together with the single marking unit 30 (i.e. unit 2) and the dual marking unit 32 (i.e. unit 8). After all three of the units 30 and 32 (i.e. units 1, 2, and 8) complete marking of the workpieces, the dual marking unit 32 (i.e. unit 8) resumes marking operations again in accord with, for example, the marking units 30 and 32 (i.e. units 4, 5, and 6). Consequently, when the aforementioned units 30 and 32 complete marking, the dual marking unit 32 (i.e. unit 1) starts marking with, for example, another dual marking unit 32 (i.e. unit 3) and the single marking units 30 (i.e. units 7 and 9) on the corresponding marking fields.

Alluding to the above, in addition to coordinating the user interface and providing marking process status, the main controller 16 provides all marking units 30 and 32 in the network with marking instructions in real-time. One possible way to archive that would be that the main controller 16 sends marking instructions to marking units 30 and 32 (i.e. units 1, 2, and 8) first (as shown in FIG. 6) and then starts marking process on these marking units by sending at least one start command, and while these units perform marking, the main controller 16 sends marking instructions to the marking units 30 and 32 (i.e. units 4, 5, 6, and 8), which would put the data into the their respective buffers and wait for the start command signaled from the main controller 16. The main controller 16 would then determines (by reading the status from the marking units, for example) that the first set of marking units 30 and 32 (i.e. units 1, 2, and 8) completed marking and starts the marking process on the next set of marking units 30 and 32 (i.e. units 4, 5, 6, and 8) by signaling at least one start command, sending marking instructions to the next set of marking units 30 and 32 (i.e. units 1, 3, 7, and 9) after that.

Alluding to the above, it is imperative to prevent the main controller 16 from constantly polling the status from all marking units 30 and 32 thereby preventing the possibility of putting heavy load on the network and overloading the main controller 16, which needs to perform many time-consuming calculations just to generate marking instructions for all marking units 30 and 32 in the marking network, and more often than not, would not have the possibility to constantly check the status of all marking units 30 and 32. All of this would compromise the real-time performance of the entire marking process and would definitely require using a more expensive and powerful controller along with a network interface with more bandwidth to accommodate the higher traffic on the network. To provide real-time control of the marking process on a plurality of marking fields without concerning the main controller 16 with hard real-time requirements of the marking process, the system 10 of the present invention provides a method for temporal and spatial marking process control. The method is called ‘spatial’ because the method is adaptable to control a network of spatially distributed marking units 30 and 32, all of which can be sited at different locations, as illustrated in FIGS. 1 and 2, and on different conveyors 40. This method is also called ‘temporal’ because it provides a synchronization mechanism to control the marking process on all marking units 30 and 32 in real-time.

According to the present invention, the presented method 1) is workflow-based as the means of controlling the distributed marking process on all marking units in the marking network; 2) is timeslot-based as the means of dividing the entire marking process on all marking units into different timeslots, wherein each of the timeslots is represented by a group of activities; 3) allows generation and execution of Workflow Control instructions as the synchronization mechanism for controlling the execution of different activities by the distributed marking units in real-time without the main controller intervention.

The possible types of activities include, but are not limited to, a Marking activity that determines the marking process on at least one single marking unit 30 or dual marking unit 32; a Sequence activity that executes a group of activities one at a time, in a defined order; a Parallel activity, which executes two or more sequences of activities in parallel, waiting for all sequences to complete before continuing; a Repeat activity, which repeatedly executes one or more activities as long as a condition is true, i.e. as long as a counter has not reached the programmed value; an If/Else activity that conditionally runs one of two or more activities depending on some internal or external condition like input/output signals, counters, or the result of executing of other activities; a Digital Input-Output activity, which allows to set an output to ‘0’ or ‘1’ or wait for an input event, i.e. waiting for an input to become ‘0’ or ‘1’, or for a rising or falling edge of the input signal; an Analog Input-Output activity, which allows to set the output of a digital-to-analog converter to a particular voltage or read an external signal with an analog-to-digital converter; an Automation activity, which allows sending and receiving data from different interfaces like Ethernet, Industrial Ethernet, USB, FireWire, Serial Digital Interface, CAN, RS232/422/485 for process control; a Delay activity that suspends the workflow execution for a specified amount of time; a Send E-mail activity, which sends an e-mail to the specified address (for example, after the system 10 finishes executing all marking instructions generated by the main controller 16); a Message Box activity, which interrupts the workflow execution and shows a message box to an operator (not shown) waiting for an input to continue the process; a Report Activity that provides reporting services for the marking network, entire marking process, or part of the marking process; a Database activity, which performs different database operations such as retrieving marking data from a database, marking job serialization, persisting the process state, or saving the status of the marking process into a database; a Quality assurance activity that checks the quality of marking (for example, using a barcode reader, reads and validates barcodes); a Visual Recognition activity that performs recognition of workpieces and generates a multi-dimensional image of the same to align a marking field, compensate for any marking part misalignment, or determine the actual mark location on the workpieces; and ID reader activity for remotely retrieving marking content and/or workpieces' type information from at least one ID tags attached to or incorporated into at least one of the workpieces; a Unique Identification (UID) Read activity that communicates with an external UID reader to read the UID mark on the workpieces; a UID Verify activity that performs mark quality verification according to ISO 15415 and SAE AS9132 standards; a UID Validate activity, which validates UID marks for syntax and formatting (such as message header and identifiers) according to ISO 15434 standard; a UID Registry activity that submits Unique Identification data to the UID Registry; a UID Wizard activity that generates Unique Item Identifiers and guaranties their uniqueness; an Invoke External Workflow activity, which invokes an external workflow whereby providing a mechanism for synchronizing processes in different marking networks at different locations as illustrated in FIGS. 1 and 2; a Run External Program activity that runs an external application (synchronously or asynchronously) on the main controller 16 or any of the single marking units 30 or dual marking unit 32; a Web Service Input activity that enables receiving data from a Web service into the workflow; a Web Service Output activity that enables sending data to a Web service from within the workflow; a Queue activity, which stores the result of an activity execution in a queue for further consumption by the activities in the workflow or reads data from the queue; a Custom activity that provides a means to design a custom action and embed it into the workflow; a Workflow Control activity, which represents a synchronization mechanism to control the distributed marking process on all marking units 30 and 32 without the main controller 16 intervention.

Every Marking activity in a process workflow represents a set of marking and control instructions, which are executed in the time slot of that Marking activity by one marking unit 30 and/or 32. Therefore, every Marking activity must be assigned to a particular marking unit 30 and/or 32 that will execute the marking and control instructions of that Marking activity. Depending on a technological process, any particular marking unit 30 and/or 32 in the network executes at least one Marking activity in the process workflow.

FIGS. 6 through 8 illustrate various flow charts of the exemplary embodiments of the inventive method of the marking applications performed by the system 10. One of the possible embodiments of the marking process workflow is shown in FIG. 6, wherein the marking process workflow includes and is not limited to a sequence of different activities, every one of which is a single activity (like Marking, Delay, or Automation) or a composite activity (like Parallel or Sequence). Preferably, the composite activity includes any number of single activities as well as any number of other composite activities. The workflow executes each activity sequentially one at a time. When executing the parallel activity, sequential branches of the same are scheduled to run in parallel, waiting for all paths to complete before going further down the sequence.

As shown in FIG. 6, the first activity scheduled to run is a parallel activity number 1, which includes three sequence activities, every one of which includes a marking activity. When the parallel activity number 1 runs, all three marking units 30 and/or 32 (i.e. units 1, 2, and 8) perform simultaneous marking of the same or different content on their corresponding marking fields. Since the marking units 30 and/or 32 could finish marking at different times, depending of the marking instructions generated by the main controller 16, the workflow waits until all three marking units 30 and/or 32 complete marking process, whereby a parallel activity number 2 starts executing the marking process, i.e. signaling the marking units 30 and/or 32 (i.e. units 4, 5, 6, and 8) to run in parallel. After the parallel activity number 2 finishes executing all its branches, a parallel activity number 3 starts to run. This parallel activity includes four sequence activities, and two of them have two marking activities scheduled to run sequentially, meaning that marking unit 30 (i.e unit 2) waits for the marking unit 32 (i.e. unit 1) to finish marking before starting executing its own marking instructions, while the marking unit 30 (i.e. unit 5) waits for the marking unit 30 (i.e. unit 7). After all six marking activities (i.e. marking processes on units 1, 3, 7, 9, 2, and 5) are complete, the workflow starts executing a parallel activity number 4.

Alluding to the above, the method of the present invention allows to perform hard real-time control of the entire marking process without an intervention of the main controller 16, thereby sparing the main controller 16 for such ‘soft’ real-time tasks as providing the status of each marking unit 30 and 32 and generating and sending marking instructions to the buffers of each marking units 30 and 32 over the network. The main difference between a real-time control of the marking network and just providing marking data ‘in-time’ is that the main controller 16 does not need to generate marking instructions for each marking unit 30 and 32 at the pace of actual marking, but rather it generates marking instructions in advance and sends them over the network to the marking units 30 and 32 for buffering, addressing each unit by its ID. During the marking process, all units 30 and 32 get the marking instructions from their respective buffers and execute them at the speed of actual marking (which is very high in many marking applications) while the main controller 16 populates the units' buffers asynchronously at its own pace, thereby using the Workflow Control activities by inserting at least one Workflow Control instruction into the buffers of the marking units 30 and 32 at the workflow activities' time boundaries.

Alluding to the above, a Workflow Control activity includes, but is not limited to, the following set of Workflow Control instructions: wait for the specified command from the main controller 16; wait for any command from the main controller 16; send the specified command to the main controller 16; send the specified command to the specified marking unit 30 or 32; send the specified command to a plurality of marking units 30 and/or 32; broadcast the specified command to all marking units 30 and/or 32; wait for the specified command from the specified marking unit 30 and/or 32; wait for any command from the specified marking unit 30 and/or 32; wait for the specified command from a plurality of marking units 30 and/or 32; wait for any command from a plurality of marking units 30 and/or 32; wait for the specified command from any of marking units 30 and/or 32; wait for any command from any marking unit 30 and/or 32; wait for the specified command from the specified marking unit 30 and/or 32 the specified number of times; wait for any command from the specified marking unit 30 and/or 32 the specified number of times; wait for the specified command from any marking unit 30 and/or 32 the specified number of times; wait for any command from any marking unit 30 and/or 32 the specified number of times; wait for the specified command from a plurality of marking units 30 and/or 32 the specified number of times; wait for any command from a plurality of marking units 30 and/or 32 the specified number of times.

Referring back to FIG. 6, the marking unit 32 number 1 marks indicia on stationary or moving parts at three different moment of time: when the system 10 executes the parallel activity number 1, parallel activity number 3, and parallel activity number 4. In order for the marking unit 32 number 1 to perform marking at the three moments of time autonomously without the main controller 16 intervention (i.e. polling the status of the marking unit) and at the same time synchronize its marking process with the marking processes on all other marking units 30 and 32 in the network, the main controller 16 generates at least the following instructions for the dual marking unit 32 number 1: Workflow Control instruction “Wait for Start”; instructions for the marking process in the timeslot of Parallel activity number 1; Workflow Control instruction “Send Marking Finished to unit number 4”; Workflow Control instruction “Send Marking Finished to unit number 5”; Workflow Control instruction “Send Marking Finished to unit number 6”; Workflow Control instruction “Send Marking Finished to unit number 8”; Workflow Control instruction “Wait for Marking Finished from unit number 4”; Workflow Control instruction “Wait for Marking Finished from unit number 5”; Workflow Control instruction “Wait for Marking Finished from unit number 6”; Workflow Control instruction “Wait for Marking Finished from unit number 8”; instructions for the marking process in the timeslot of Parallel activity number 3; Workflow Control instruction “Send Marking Finished to unit number 2”; Workflow Control instruction “Wait for Marking Finished from unit number 2”; Workflow Control instruction “Wait for Marking Finished from unit number 3”; Workflow Control instruction “Wait for Marking Finished from unit number 5”; Workflow Control instruction “Wait for Marking Finished from unit number 9”; instructions for the marking process in the timeslot of Parallel activity number 4.

Preferably, the marking units 30 and 32 execute the Workflow Control instructions that are related to waiting for commands from the other marking units in parallel. Referring back to FIG. 6, that means that the marking unit 32 number 1 executes, for example, the Workflow Control instructions “Wait for Marking Finished from unit number 2”, “Wait for Marking Finished from unit number 3”, “Wait for Marking Finished from unit number 5”, and “Wait for Marking Finished from unit number 9” simultaneously thereby waiting for all of them to complete (which means receiving all the commands from the corresponding marking units) before executing the next set of instructions.

Alluding to the above, the main controller 16 generates one Workflow Control instruction “Wait for Marking Finished from any unit 4 times” instead of generating, for example, the four Workflow Control instructions “Wait for Marking Finished from unit number 2”, “Wait for Marking Finished from unit number 3”, “Wait for Marking Finished from unit number 5”, and “Wait for Marking Finished from unit number 9”. After receiving four “Marking Finished” instructions from the units 30 and/or 32 numbers 2, 3, 5, and 9, the marking unit 32 number 1 continues executing the next set of instructions.

Similarly, for the marking unit 30 number 2, the main controller 16 generates at least the following set of instructions: Workflow Control instruction “Wait for Start”; instructions for the marking process in the timeslot of Parallel activity number 1; Workflow Control instruction “Send Marking Finished to unit number 4”; Workflow Control instruction “Send Marking Finished to unit number 5”; Workflow Control instruction “Send Marking Finished to unit number 6”; Workflow Control instruction “Send Marking Finished to unit number 8”; Workflow Control instruction “Wait for Marking Finished from unit number 1”; instructions for the marking process in the timeslot of Parallel activity number 3; Workflow Control instruction “Send Marking Finished to unit number 1”; Workflow Control instruction “Send Marking Finished to unit number 8”.

The process of generating instructions repeats for all marking units 30 and 32 in the network. In the end, the main controller 16 generates at least one buffer in its memory comprising all combined marking and control instructions for all units 30 and 32. After generating the instructions, the main controller 16 sends them to the corresponding units 30 and 32, addressing each unit by its unique ID, and then broadcasts at least one control command to all units 30 and 32 to start the process. After receiving the command, all units 30 and 32 in the network start executing their instructions, but only the units 30 and 32 numbers 1, 2, and 8 start actual marking, the rest wait for the corresponding Workflow Control instructions to be executed. After sending the instructions to the marking units (or dynamically uploading them to the units depending on the size of their buffers and the size of the marking job), the main controller 16 does not take part in the real-time control of the entire marking process. Only when the markings units 30 and 32 numbers 1, 2, and 8 finish executing their control and marking instructions, they execute also the Workflow Control instructions from their buffers, signaling to the next set of units 30 and 32 numbers 4, 5, 6, and 8 to start executing their instructions in the time slot of the parallel activity number 2. When the marking units 30 and 32 numbers 4, 5, 6, and 8 finish executing their control and marking instructions in the time slot of the parallel activity number 2, they also execute their respective Workflow Control instructions, thereby starting the process on the next set of units 30 and 32 numbers 1, 3, 7, and 9 in the time-slot of the parallel activity number 3. When the marking units 30 and 32 numbers 1 and 7 finish executing their control and marking instructions, they execute their Workflow Control instructions, thereby starting marking process on the units 30 and 32 numbers 2 and 5 in the time-slot of the parallel activity number 3. Finally, when the marking units 30 and 32 numbers 2, 3, 5, and 9 finish executing their control and marking instructions, they also execute their Workflow Control instructions, thereby starting the process on the next set of units 30 and 32 numbers 1 and 8 in the timeslot of the parallel activity number 4. The marking process ends when the marking units 30 and 32 numbers 1 and 8 finish executing their instructions in the timeslot of the parallel activity number 4.

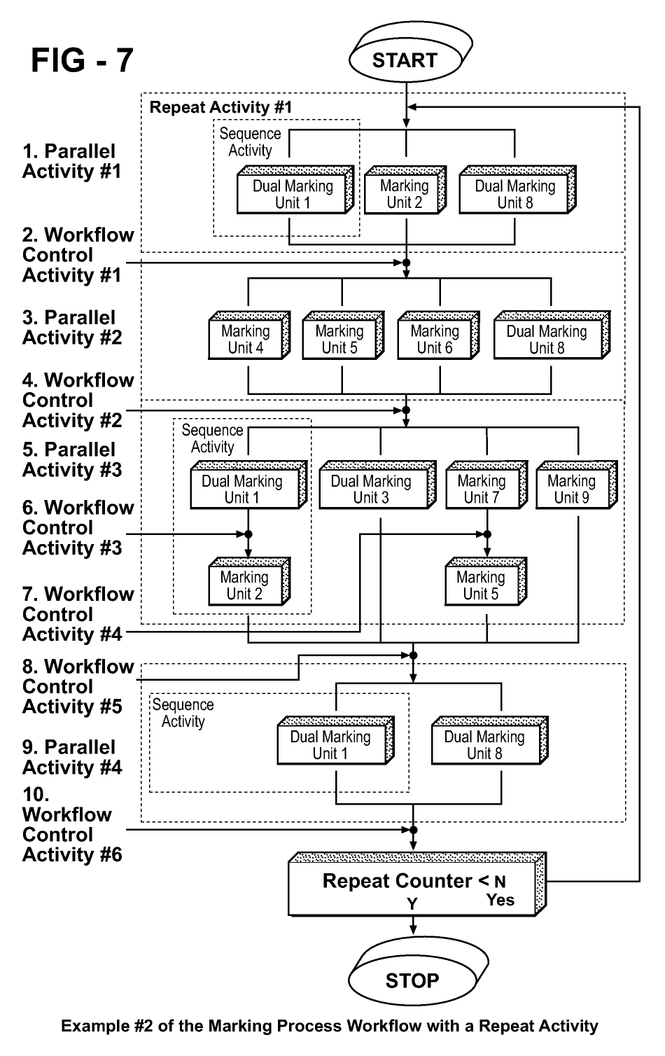

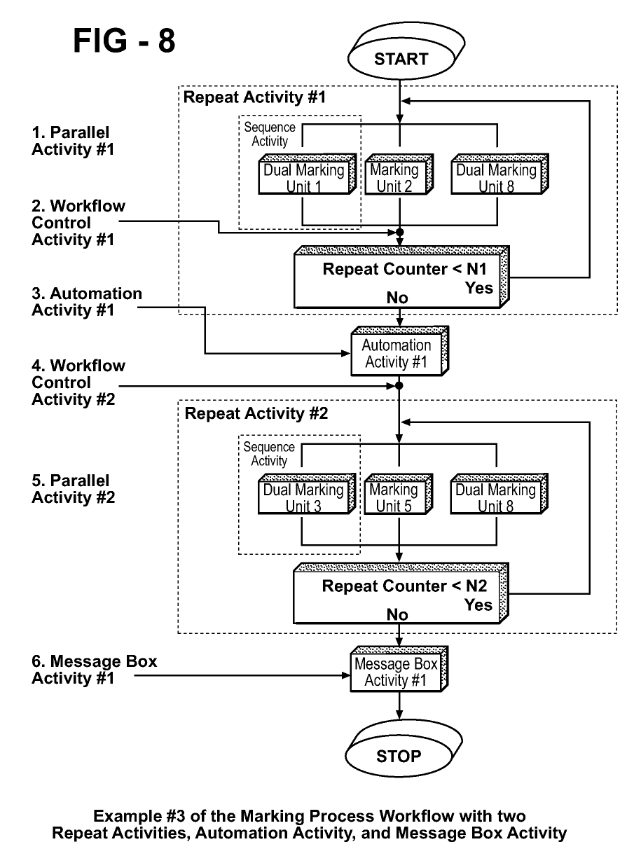

Another embodiment of the marking process workflow is shown in FIG. 7. Many technological processes require repeatedly running a particular marking process a specified number of times, like for example, sequentially marking different serial numbers and barcodes on a particular number of production parts on the moving conveyor 40. The parts could also be sited on a palette (not shown), in which case the marking unit 30 or 32 performs marking indicia on the parts the number of times corresponding to the number of the production parts on the palette. The technological process could also have a requirement for marking many palettes moving on the conveyor 40. The present invention provides means of performing such operations by using the Repeat activity, which is a composite activity that can host any number of other activities either single or composite.

The process workflow presented in FIG. 7 is similar to the process workflow in FIG. 6 with the only difference that a Repeat activity is added at the end of the workflow. The activity has a counter that can be set to a particular value corresponding to the number of times the whole process needs to run. The system 10 continues executing the workflow until the counter expires.

FIG. 8 shows another alternative embodiment of the marking process workflow of the present invention, wherein two Repeat activities are implemented, with each of these activities hosting a Parallel activity, every one of which has three branches of Marking activities working in parallel. After the first repeat activity finishes executing, the Automation activity number 1 sends the status of the marking process over an interface such as Ethernet, any of the Industrial Ethernet protocols, any of the Internet protocols, any of the wireless protocols, USB, FireWire, SDI, CAN, RS232/422/485, and the like, without limiting the scope of the present invention. The next step presents the repeat activity number 2, which executes the respective Marking activities the specified number of times. Finally, a Message Box activity number 1, upon execution, shows the operator the status of the marking process.

All of the aforementioned embodiments of the present invention illustrate the method for temporal and spatial marking process control, which allows the marking units 30 and 32 to send and receive control and status information among each other without having the main controller 16 to perform the complex task of controlling the entire marking process in real-time. The marking units 30 and 32 provide an economic and rapid method of writing, bar coding, and decorative marking of the production parts formed from plastics, metals, and other materials, thereby providing many advantages of using this technique over current technologies due to ease of application at which the layout and process workflow can be adjusted using graphic computer programs and ease of integration into a production line.

The range of application of the present invention includes and is not limited to irradiation of a target surface, like e.g. a plastic surface, with laser light, thereby providing it with permanent informational indicia marks, such as characters, letters, figures, symbols, bar codes or images, date codes, batch codes, bar codes or part numbers, functional marks, such as computer keyboard and electronic keypad characters, and decorative marks, such as company logos. Furthermore, in some application marks are moreover made visible and readable in a dark or dimly lit environment as e.g. in order to read informational indicia on items, such as clocks, emergency exit signs, safety information signboards, interior automobile control buttons, and the like. The term “indicia” further refers to any laser mark including, but not limited to, alphabetical characters, numbers, barcodes, drawings or patterns. Laser marking is a contact-free procedure, which makes marking possible even on soft, irregular surfaces that are not readily accessible. The laser marking is ink-free, which provides long-lasting applications and it is solvent-free, which makes it more ecologically acceptable and resistant to passage in processing baths.

The laser marking device 10 and the method of the present invention provide numerous other advantages over the aforementioned prior art devices and methods. One of these advantages is a unique laser marking system that is cost effective and flexibly to be adapted by any manufacturing environment and is very compact and does not require a lot of space on the factory floor. Another advantage of the present invention provide the laser marking device 10 that does not have high cost of maintenance and is easily mounted on a robot arm (not shown) for marking various workpieces thereby simultaneously performing marking operation in several shops of a manufacturing facility through a local network using at lest one of the Ethernet, Industrial Ethernet, and wireless protocols, if the shops are located in a single manufacturing facility, as illustrated in FIG. 1, and by using the Internet between various manufacturing facilities located in different states and countries worldwide, as illustrated in FIG. 2.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A laser marking device for processing workpieces having at least one ID tag associated with at least one of marking content and type of the workpieces and positioned relative said laser marking device comprising:
at least one conveyance device for moving the workpieces along a processing path,
a plurality of units adjacent one another and movable relative said processing path with each of said units adaptable for scanning the workpieces to generate a multi-dimensional image of the workpieces and remotely retrieving at least one of the marking content and the type of the workpieces thereby generating a laser beam and controllably steering said laser beam onto the workpieces for marking the workpieces in at least one of simultaneous and sequential modes based on predetermined input data representing patterns of multi-dimensional images of the workpieces, types of the workpieces, marking locations and marking content, and
a controller spaced from said units and presenting a network communication with each of said units with said controller storing said predetermined input data thereby coordinating a marking process of each of said units by distributing said input data to said units and signaling at least one command to each of said units thereby starting marking process on each of said units as said multi-dimensional image is matched with said predetermined patterns and said predetermined type of the workpieces is matched with the type of the workpieces being remotely retrieved by said units.

2. A laser marking device as set forth in claim 1 wherein said controller includes a process control software operably communicating with said units through a high-speed interface for sending to said units said predetermined input data and said at least one command.

3. A laser marking device as set forth in claim 1 wherein each said unit includes a comparative software for generating said multi-dimensional image of the workpieces, matching said multi-dimensional image with said predetermined patterns, and matching said predetermined types of the workpieces retrieved from at least one ID tag thereby marking the workpieces with said predetermined data at said marking locations.

4. A laser marking device as set forth in claim 1 wherein each said unit includes at least one ID reader module for remotely retrieving at least one of the marking content and the type of the workpieces.

5. A laser marking device as set forth in claim 4 wherein said ID reader module is further defined as a Radio Frequency Identification (RFID) reader device for remotely retrieving at least one of the marking content and the workpieces' type information from at least one RFID tags attached to at least one of the workpieces.

6. A laser marking device as set forth in claim 4 wherein said ID reader module is further defined as at least one of magnetic reader and capacitive reader devices for remotely retrieving at least one of the marking content and the workpieces' type information from at least one magnetic and capacitive tags associated with at least one of the workpieces.

7. A laser marking device as set forth in claim 4 wherein said ID reader module is further defined as a barcode reader device for remotely retrieving at least one of the marking content and the workpieces' type information from at least one barcode tags associated with at least one of the workpieces.

8. A laser marking device as set forth in claim 2 wherein said high-speed interface utilizes at least one of Ethernet protocols thereby facilitating communication between said controller and said units at data link and physical layers.

9. A laser marking device as set forth in claim 2 wherein said high-speed interface utilizes at least one of Industrial Ethernet and Internet protocols thereby facilitating communication between said controller and said units at data link, network and transport layers.

10. A laser marking device as set forth in claim 2 wherein said controller is networked with said units through at least one of wireless protocols, TCP/IP protocols and raw Ethernet frames.

11. A laser marking device as set forth in claim 10 wherein each said unit includes at least two lasers, two scan-heads, two conveyor control modules, two ID reader modules, and two visual recognition modules to perform simultaneous marking on at least two different conveyance devices at same or different motion speeds.

12. A laser marking device as set forth in claim 11 wherein each said unit is assigned a customized identification number (ID) used by said controller to address each unit, said units being adaptable to address each other thereby facilitating communication between said controller and said units.

13. A laser marking device as set forth in claim 12 wherein each unit is at least one of a single marking unit and a dual marking unit each adaptable to perform high-speed simultaneous marking operations on at least one of said marking fields.

14. A laser marking device as set forth in claim 13 wherein each unit is adaptable to receive and execute process control and status commands, laser control and status commands, scan-head control and status commands for multi-dimensional beam deflection, visual recognition control and status commands for scanning the workpieces and generating said multi-dimensional image of the workpieces, ID reader control and status commands for remotely retrieving said marking content and workpieces' type information, analog and digital I/O control and status commands, conveyor control and status commands, motion control and status commands, and automation control and status commands.

15. A method of marking workpieces having at least one of ID tags associated with at least one of marking content and types of the workpieces as the workpieces positioned relative to a laser marking device, said method comprising the steps of:
positioning a plurality of units relative to at least one conveyance device to move the workpieces along a processing path;
orienting the units to scan the workpieces thereby generating a multi-dimensional image of the workpieces to recognize the workpieces and to process the workpieces in at least one of simultaneous and sequential modes based on a predetermined input data representing patterns of multi-dimensional images of the workpieces, marking locations and marking content;
orienting the units relative to the workpieces to retrieve information about marking content and the types of the workpieces from at least one ID tags associated with at least one of the workpieces thereby recognizing the workpieces and determining the marking content for each of the workpieces; and
connecting a controller having the predetermined data stored therein and the units through a network communication to coordinate a marking process of each unit.

16. A method of marking workpieces as set forth in claim 15 including the step of assigning an ID for each unit in the network.

17. A method of marking workpieces as set forth in claim 16 including the step of creating a process workflow for the marking of the workpieces and dividing the workflow into timeslots with each timeslot being represented by a group of activities.

18. A method of marking workpieces as set forth in claim 17 including the step of defining at least one action for each activity in the workflow.

19. A method of marking workpieces as set forth in claim 18 including the step of assigning a marking unit for each marking activity in the process workflow.

20. A method of marking workpieces as set forth in claim 19 including the step of generating marking and control instructions by the controller for all marking units in the network.

21. A method of marking workpieces as set forth in claim 20 including the step of combining the instructions for all units into at least one buffer in the controller memory.

22. A method of marking workpieces as set forth in claim 21 including the step of inserting at least one Workflow Control instructions in the at least one buffer at the activities' time boundaries in order to provide a synchronization mechanism to exchange information among the units during the marking process without concerning the controller with hard real-time requirements of the marking process.

23. A method of marking workpieces as set forth in claim 21 including the step of distributing all or at least part of the generated instructions by the controller between the buffers of the units using the assigned IDs.

24. A method of marking workpieces as set forth in claim 23 including the step of starting the marking process by the controller broadcasting at least one command to the units, all the units executing the corresponding instructions from their buffers and dynamically yielding control to each other by executing and communicating the Workflow Control instructions inserted into the buffers of the units at the activities' time boundaries.

25. A method of marking workpieces as set forth in claim 24 including the step of dynamically distributing the remaining instructions by the controller from at least one buffer to the buffers of the units whereas the units execute the instructions from the respective buffers.

26. A laser marking device for processing workpieces having at least one ID tag associated with at least one of marking content and types of the workpieces with the workpieces being movable relative said laser marking device, said laser marking device comprising:
at least one conveyance device for moving the workpieces along a processing path;
a plurality of units adjacent one another and movable relative said processing path for scanning the workpieces thereby generating a multi-dimensional image of each workpiece and recognizing the position and orientation of each workpiece, for retrieving information about at least one of the marking content and the types of the workpieces from at least one of the ID tags thereby recognizing each workpiece, and for steering the laser beam from said units onto the workpieces thereby marking the workpieces;
a controller networked with each of said units;
a software of said controller for generating and storing predetermined data thereby allowing said controller to at least coordinate a marking process of each of said units by distributing the predetermined data to said units and signaling at least one command to each said unit; and
a comparative software of said units for generating a multi-dimensional image of the workpieces, matching said multi-dimensional image with predetermined patterns, and matching predetermined types of the workpieces with information about the types of the workpieces retrieved from at least one of the ID tags associated with at least one of the workpieces.

27. A laser marking device as set forth in claim 26 wherein each said unit generates the laser beam thereby controllably steering the laser beam onto the workpieces for processing the workpieces in at least one of simultaneous and sequential modes based on said predetermined input data representing patterns of multi-dimensional images of the workpieces, types of the workpieces, marking locations and marking content.

28. A laser marking device as set forth in claim 27 wherein said network communication is further defined by at least one of the Ethernet, Industrial Ethernet, Internet, and wireless protocols.

29. A laser marking device as set forth in claim 27 wherein said controller is integral with at least one of said units.

30. A laser marking device as set forth in claim 27 wherein said controller and said distributed network of said units are further defined as a node with a customizable ID in a higher level distributed network with a higher level controller thereby facilitating implementation of hierarchical distributed marking networks wherein the level of said hierarchy goes to any depth.

31. A laser marking device as set forth in claim 30 wherein said process workflow executed by at least one said controllers is further defined as at least one activity in at least one higher level process workflows executed by said higher level controller in said higher level distributed network.
